(19) United States
(12) Patent Application Publication
(10) Pub. No.: US 2025/0058295 A1
(43) Pub. Date: Feb. 20, 2025

(54) Reactor

(71) Applicant: Air Products and Chemicals, Inc., Allentown, PA (US)

(72) Inventors: VINCENT WHITE, Surrey (GB); ANDREW SHAW, Sunbury on Thames (GB); CARMINE IANDOLI, Barcelona (ES); TORI DAWN COURTNEY, Phoenixville, PA (US); SIMON CRAIG SALOWAY, Surrey (GB); JOSHUA E. MIDDAUGH, Gilbertsville, PA (US)

(73) Assignee: Air Products and Chemicals, Inc., Allentown, PA (US)

(21) Appl. No.: 18/233,480

(22) Filed: Aug. 14, 2023

(51) Int. Cl. B01J 19/00; B01J 19/24; C01B 3/04

(52) U.S. Cl. CPC B01J 19/006; B01J 19/2425; C01B 3/047; B01J 2219/00765

(57) ABSTRACT

In a reactor comprising a cylindrical combustion chamber, at least one burner and a circular array of catalyst-containing tubes, there is provided a ring baffle on the wall opposite the burner(s) extending into the combustion chamber which redirects combustion gas around the combustion chamber, thereby enabling more even heat distribution and an increase in overall heat transfer.

### TECHNICAL FIELD OF THE INVENTION

The present invention is in the field of reactors, specifically reactors for carrying out endothermic catalytic reactions to produce, for example, hydrogen gas either by steam reforming of hydrocarbon feedstock, e.g., natural gas, or by cracking (or “dissociation”) of ammonia feedstock.

### BACKGROUND OF THE INVENTION

An “endothermic” reaction is a reaction that requires energy, usually heat energy, from the surroundings to provide the activation energy for the reaction to occur. Examples of endothermic reactions include cracking (or “dissociation”) of ammonia gas into hydrogen (H₂) gas and nitrogen gas (N₂), and steam reforming of hydrocarbons to form syngas comprising H₂ and carbon monoxide gas (CO). The endothermic nature of these reactions dictates the need for a fired reactor, or furnace.

The ammonia cracking reaction is represented by the following reaction equation:

2NH₃ [symbol] 3H₂+N₂

The standard heat of reaction (per mole of ammonia) at 1 bar and 0° C. is 45.47 KJ/mol. The process is usually performed over a catalyst.

Steam reforming or steam methane reforming (SMR) is a process for producing a mixture of H₂ and CO by reaction of hydrocarbon feedstock with water. Natural gas is commonly used as the feedstock but other hydrocarbons may be used such as liquefied petroleum gas (LPG) and naphtha. The SMR reaction is represented by the following reaction equation:

CH₄+H₂O [symbol] CO+3H₂

The reaction is strongly endothermic (ΔH_{SR}=206 KJ/mol) and is usually performed over a catalyst.

As these reactions are both equilibrium reactions, there will generally be small amounts of the reactants in the product gas. The amount of residual reactant in the product gas, generally referred to as “slip” of the reactant(s), may be varied by changing the temperature and/or the pressure at which the reaction takes place with higher temperatures and/or higher pressures favoring conversion thereby reducing the slip.

“Shell-and-tube” reactors for carrying out endothermic reactions are well known in the art. Examples of such reactors include the reactors disclosed in GB1004234A, US2007/0187079A, U.S. Pat. No. 6,808,689A and CN202036974A. Generally, these reactors have a cylindrical shell containing a plurality of catalyst-filled tubes. Hot gases circulate in the space between the shell and the tubes and the gas to be processed passes through the tubes. The hot gases provide the heat necessary for the endothermic reaction to take place. The reactors in these references also have plate baffles located horizontally within the reactors to divert the hot gases around the tubes, hence extend the flow pattern and increase mixing between hot and cooler gases.

Such annular reactors can also be built as cylindrical enclosures with one or more burners fired from the top or bottom surface. Process gas flows in tubes containing catalyst arranged circumferentially inside the cylinder. Hot combustion gases provide heat mostly through radiation to the tubes and then leave through dedicated ports designed to distribute the flow evenly. The reactor tubes themselves may contain an additional tube inside such that heat exchange can occur between the innermost tube and the annulus between this innermost tube and the hot combustion gases. Examples of such reactors are disclosed in U.S. Pat. No. 6,835,360A, EP4025333A, EP2223739A, KR20220096295A, EP2394735A and US2022152576A.

U.S. Pat. No. 6,835,360A discloses an endothermic catalytic reaction apparatus that includes a combustion chamber containing a plurality of tubular reaction chambers arranged concentrically around an axially extending radiant burner located centrally within the chamber.

Each tubular reaction chamber is defined as the annular space between an outer conduit and an inner conduit located coaxially within the outer conduit, the annular space being filled with catalyst. Reactant gases enter the reaction chamber through an inlet, pass through the catalyst bed in the annular space and then pass through the inner conduit and leave through an outlet. Gases passing through the inner conduit transfer heat to the reactant gases passing through the reaction chamber.

The radiant burner transfers radiant energy uniformly in a 360° arc to the surface of the outer conduits. Each tubular reaction chamber has a convection chamber. Combustion gases exiting the radiant burner are introduced into the convection chamber that is concentrically disposed around a portion of the outer conduit in the proximity of the tubular conduit end containing the reactant gas inlet. After providing heat by convection to the outer conduit, the combustion gases leave through an outlet.

Annular reactors of the type disclosed in U.S. Pat. No. 6,835,360A are generally designed for smaller capacity compared to typical SMR or cracking furnaces and often rely on premixed burners to provide heat. In the relatively small reactor volume, a low momentum flame manages to achieve a smooth heat distribution. Premixed burners, however, cannot always be used when fuel has a high hydrogen content, and may lead to higher NOₓ emissions. To overcome these limitations, non-premixed burners like those used on larger furnaces can be installed. Use of such burners typically results in combustion gases entering the reactor at higher speed. Due to the small size of the reactor, combustion gas momentum cannot be dissipated which can lead to uneven heat distribution and tubes locally overheating if hot gas impinges directly on to the tubes.

There is a need generally for more efficient fired reactors and, in particular, for smaller annular reactors using non-premixed burners with improved heat transfer.

### BRIEF SUMMARY OF THE INVENTION

According to a first aspect of the present invention, there is provided a reactor, e.g., an endothermic reactor, comprises an insulated cylindrical side wall having a first end and a second end opposite the first end, said insulated cylindrical side wall being closed at the first end with a first insulated end wall and at the second end with a second insulated end wall, the insulated cylindrical side wall and insulated end walls defining a combustion chamber having an internal diameter, an internal height and a longitudinal axis parallel to the cylindrical side wall; at least one burner located centrally in the first insulated end wall; a plurality of catalyst-containing tubes extending through one of the insulated end walls into the combustion chamber towards the opposite insulated end wall, said tubes being parallel to the insulated cylindrical side wall and arranged in a circular array that is coaxial with the longitudinal axis of the combustion chamber; at least one outlet for combustion gas extending through the insulated end wall through which the plurality of catalyst-containing tubes extends, said at least one outlet being located adjacent said tubes; and a ring baffle located on the second insulated end wall and extending from the second insulated end wall into the combustion chamber, said ring baffle being coaxial with the longitudinal axis of the combustion chamber, wherein the circular array of the plurality of catalyst-containing tubes is located between the ring baffle and the insulated cylindrical side wall, and wherein the ring baffle has an internal diameter that is in a range from about 55% to about 90% of the internal diameter of the combustion chamber, and a height that is in a range from about 5% to about 30% of the internal height of the combustion chamber.

The inventors have determined that a ring baffle having an appropriate height and positioned in an appropriate location on the wall opposite the burner(s) redirects combustion gas from the burner(s), forcing the gas to recirculate in the combustion chamber of the reactor before reaching the catalyst-containing tubes. Recirculation of the combustion gas increases the residence time of the combustion gas within the combustion chamber and provides more even heat distribution, thereby increasing overall heat transfer by up to about 10%, and/or reducing the tube wall temperature near the second end wall by up to about 100° C., e.g., up to about 80° C. or up to about 70° C., and/or increasing the temperature of the gas on exit from the catalyst-containing tubes, thereby reducing the amount of unreacted gas, e.g., ammonia or methane, from the feed.

The invention enables the upgrading of existing annular fired reactors with new, low NOₓ burners by retrofitting the reactor with a ring baffle.

According to a second aspect of the present invention, there is provided a method of carrying out an endothermic reaction, said method comprising combusting a fuel with an oxidant gas in the burner(s) to heat the catalyst-containing tubes of the reactor according to the first aspect; and passing a feed gas through the catalyst-containing tubes to produce a synthesis gas.

According to a third aspect of the present invention, there is provided a use of a reactor according to the first aspect to carry out an endothermic reaction, for example, ammonia cracking or steam reforming of hydrocarbon feedstock.

The present invention has particular application in endothermic reactors disclosed in U.S. Pat. No. 6,835,360A.

### BRIEF DESCRIPTION OF THE DRAWINGS

FIG. 1 depicts the movement of combustion gases within a conventional annular reactor with a non-premixed burner;

FIG. 2 depicts the movement of combustion gases within a reactor according to the present invention with a non-premixed burner;

FIG. 3 depicts a cross-section of a first embodiment of a reactor according to the present invention (with the cylindrical side wall omitted);

FIG. 4 depicts a partial cross-section of a second embodiment of a reactor according to the present invention;

FIG. 5 depicts a partial cross-section of a third embodiment of a reactor according to the present invention;

FIG. 6 is a computational fluid dynamics (CFD) model of the movement of combustion gas in a combustion chamber of an annular reactor with a non-premixed burner but without a ring baffle;

FIG. 7 is a CFD model of the movement of combustion gas in a combustion chamber of a comparative reactor having a ring baffle with an internal diameter of 50% of the internal diameter of the combustion chamber; and

FIG. 8 is a CFD model of the movement of combustion gas in a combustion chamber of a reactor according to the present invention.

### DETAILED DESCRIPTION OF THE INVENTION

Throughout the specification, any references to pressure are references to absolute pressure unless otherwise stated.

The reactor according to the present invention comprises an insulated cylindrical side wall having a first end and a second end opposite the first end. The insulated cylindrical side wall is closed at the first end with a first insulated end wall and closed at the second end with a second insulated end wall. The insulated cylindrical side wall, together with the two insulated end walls, define a combustion chamber having an internal diameter, an internal height and a longitudinal axis parallel to the insulated cylindrical side wall.

The insulation on the side wall is typically of at least essentially uniform thickness. Thus, the combustion chamber is also basically cylindrical. The term “internal diameter” is intended to refer to the diameter of the cylindrical combustion chamber measured from the inner surface of the insulation.

The insulation on the first and second end walls is also typically of at least essentially uniform thickness. The term “internal height” is intended to refer to the height of the combustion chamber measured at any point from the inner surfaces of the insulation on opposite walls.

The insulation is typically made from a refractory ceramic material such as carbides, nitrides and oxides of elements such as silicon, aluminium, magnesium, calcium, boron, chromium and zirconium. Particular examples include oxides of aluminium (alumina), silicon (silica), magnesium (magnesia) and calcium (lime). The ceramic material may be cast as bricks or spun into fibers as is known in the art.

The present invention has particular application in reactors in which the internal diameter of the combustion chamber is equal to, but is preferably greater than, the internal height of the combustion chamber. The momentum of combustion gas generated by non-premixed burners in such reactors tends not to have dissipated by the time the gas reaches the opposite wall, resulting in uneven heat distribution.

The ratio of internal diameter to internal height of the combustion chamber is typically at least 1:1. In addition, the ratio of internal diameter to internal height of the combustion chamber is typically no more than 2:1, e.g., no more than 1.5:1. Thus, the ratio of internal diameter to internal height of the combustion is typically in a range from about 1:1 to about 2:1 or from about 1:1 to about 1.5:1, e.g., about 1.1:1 or about 1.3:1 or about 1.4:1. The ratio of the internal diameter (D) and internal height (h) of the combustion chamber may be referred to as the “aspect ratio” of the chamber.

The reactor further comprises at least one burner located centrally in the first end wall. In embodiments having a single burner, the burner is located on, or along, the longitudinal axis of the combustion chamber. Where there is more than one burner, e.g., two, three or four burners, the burners are typically arranged symmetrically around the longitudinal axis of the combustion chamber.

The reactor may be top-fired or bottom-fired. In a top-fired reactor, the first insulated end wall forms the top wall (or roof) of the combustion chamber of the reactor. In a bottom-fired reactor, the first insulated end wall forms the bottom wall (or floor) of the combustion chamber of the reactor. In preferred embodiments, the reactor is a top-fired reactor.

The, or where there is more than one, each burner is typically a non-premixed burner. In premixed burners, the fuel and oxidant are mixed before entering the furnace and ignited. In non-premixed burners however, the fuel and oxidant are fed through separate ports and mix in the furnace. To achieve the high degree of mixing required for stable combustion and low emissions, the fuel and oxidant typically leave the non-premixed burner at relatively high speed and combustion gases tend to carry “high momentum” into the furnace. For this reason, non-premixed burners typically generate combustion gas with momentum greater than that generated in premixed, or radiant, burners such as those burners used in U.S. Pat. No. 6,835,360A.

Burners may be defined in terms of their “Swirl number”. The strength of the swirl imparted to a fluid on exit from a burner is quantified by the Swirl number (S), defined as the ratio of the axial flux of the angular momentum (Gφ) of the fluid to the product of the axial thrust (Gx) of the fluid and the exit radius R of the burner nozzle. Since S=Gφ/GxR, high momentum burners typically have a low Swirl number due to the high axial thrust (Gx) of the fluid.

The present invention has particular application with reactors having one or more burners having a Swirl number (s) of no more than about 0.7 or no more than about 0.6, e.g., in a range from about 0.1 to about 0.5. The skilled person would consider such burners to be high momentum burners.

Non-premixed burner(s) may be referred to as “low NOₓ” burners, i.e., burners that generate comparatively lower amounts of NOₓ.

The reactor also comprises a plurality of catalyst-containing tubes extending through one of the insulated end walls into the combustion chamber towards the opposite insulated end wall. The tubes are parallel to the insulated cylindrical side wall and arranged in a circle or circular array that is coaxial with the longitudinal axis of the combustion chamber.

The tubes may extend through the first insulated end wall towards the second insulated end wall. In these embodiments, the tubes extend through the end wall on which the burner(s) is/are located. In preferred embodiments, the tubes extend through the second insulated end wall towards the first insulated end wall. In these embodiments, the tubes extend through the end wall that is opposite the end wall within which the burner(s) is/are located.

The reactor further comprises at least one outlet for combustion (or flue) gas extending through the end wall through which the plurality of catalyst-containing tubes extends, i.e., the end wall opposite the burner(s). Thus, while the outlet(s) may extend through the first or second insulated end wall, in preferred embodiments, the outlet(s) extend through the second insulated end wall.

The at least one outlet is located adjacent or next to the tubes. The outlet(s) is/are typically located around the section of the tubes that extend through the end wall. In preferred embodiments, each tube has an annular outlet surrounding the part of the tube that extends through the second end wall. However, other embodiments are also envisaged. In this regard, an arced outlet may surround the parts of two or more tubes that extend through the end wall. Indeed, a single outlet in the form of a circular slit may embrace the parts of all of the tubes that extend through the end wall. In other embodiments, the outlets may be in the form of a ring of holes through in the second end wall located near the periphery of the end wall. In still further embodiments, there may be a plurality of non-concentric holes for flue gas exit from the combustion chamber.

The reactor comprises a ring baffle located on the second insulated end wall and extending from the second insulated end wall into the combustion chamber. The ring baffle is coaxial with the longitudinal axis of the combustion chamber.

The term “baffle” in this context refers to a surface, e.g., a wall, a vane or a panel, which directs or obstructs the flow of a fluid.

The circular array of the plurality of catalyst-containing tubes is located between the ring baffle and the insulated cylindrical side wall. There is typically a space between the circular array of tubes and the cylindrical side wall. In preferred embodiments, the circular array of tubes is adjacent, i.e., next to although not adjoining, the side wall.

### Ring Baffle

The Inventors have observed that the position of the ring baffle is critical for the invention. In this regard, the Inventors have determined that, if the ring baffle is too close to the center of the combustion chamber, then a stagnation zone will occur inside the baffle ring and the flow of combustion gas will not be directed back towards the first insulated end wall. In this case, the gas in combustion chamber near the first insulated end wall will remain cooler, the residence time will remain low, and a hot band may occur on the tubes. Thus, the Inventors have determined that the ring baffle must have an internal diameter of at least about 55% of the internal diameter of the combustion chamber. In preferred embodiments, the internal diameter of the ring baffle is at least about 60%, e.g., at least about 65%, of the diameter of the combustion chamber.

The Inventors have also determined that, if the ring is too close to the tubes, then the momentum of the flow of combustion gas will be dissipated and recirculation of the gas towards the first end wall will either not occur or will be less stable. In this regard, the Inventors have determined that the ring baffle must have an internal diameter of no more than about 90% of the internal diameter of the combustion chamber. In preferred embodiments, the internal diameter of the ring baffle is no more than about 85%, e.g., no more than about 80%, of the internal diameter of the combustion chamber.

The internal diameter of the ring baffle may be in a range from about 65% to about 80%, e.g., from about 65% to about 75%, of the internal diameter of the combustion chamber. In some embodiments, the ring baffle has an internal diameter in a range from about 68% to about 72%, e.g., about 70%, of the internal diameter of the combustion chamber. In other embodiments, the ring baffle has an internal diameter in a range from about 75% to about 85%, e.g., about 78%, of the internal diameter of the combustion chamber.

The Inventors have also observed that the height of the baffle is also critical for the invention. In this regard, the inventors have determined that, if the ring baffle is too high, then the desired recirculation pattern of combustion gases to the tubes becomes inhibited. Thus, the Inventors have determined that the height of the ring baffle must be no more than 30% of the internal height of the combustion chamber. In preferred embodiments, the height of the ring baffle is no more than about 25% of the internal height of the combustion chamber.

The Inventors have also determined that, if it is too low, then the ring baffle is unable to redirect the combustion gases back towards the first end wall, allowing some of the gas to bypass the baffle and reach the outlets directly. In this regard, the Inventors have determined that the ring baffle must have a height of at least about 5% of the internal height of the combustion chamber. In preferred embodiments, the height of the ring baffle is at least about 8%, or at least about 15% of the internal height of the combustion chamber.

The height of the ring baffle may be in a range from about 8% to about 25% of the internal height of the combustion chamber. In some embodiments, the height of the height of the ring baffle is in a range from about 8% to 12%, e.g., about 10%, or in a range from about 18% to about 22%, e.g., about 20%, of the internal height of the combustion chamber.

The Inventors have also determined that, where the internal diameter of the baffle is at least 75% of the internal diameter of the combustion chamber, the height of the baffle in preferred embodiments is at least 15% of the internal height of the combustion chamber.

In some specific embodiments, particularly where the aspect ratio of the combustion chamber is in a range from about 1.3:1 to about 1.5:1, the internal diameter of the ring baffle is in a range from about 68% to 72%, e.g., about 70%, of the internal diameter of the combustion chamber and the height of the ring baffle is in a range from about 8% to about 22%, e.g., about 10% or about 20%, of the internal height of the combustion chamber.

In other specific embodiments, particularly where the aspect ratio of the combustion chamber is in a range from about 1.3:1 to about 1.5:1, the internal diameter of the ring baffle is in a range from about 75% to 85% of the internal diameter of the combustion chamber and the height of the ring baffle is in a range from about 15% to about 25% of the internal height of the ring baffle.

For all embodiments, the ring baffle is typically a circular band extending perpendicularly from the second insulated end wall. Such a band typically has an at least substantially rectangular cross-section. However, other configurations may be suitable including regular polygonal bands; ring baffles with angled or curved walls, i.e., having a shallow concave or convex cross-section as appropriate; or ring baffles with a tapered cross-section, i.e., having a base wider than the top.

The ring baffle is also typically unperforated.

A typical thickness for the ring baffle is in a range from about 0.1 centimetres (cm) to about 15 cm, e.g., from about 0.25 cm to about 10 cm. One factor in determining the thickness of the ring baffle is the material from which it is made. In this regard, the ring baffle may comprise, or be made from, a metal alloy or a refractory ceramic material. If made from a ceramic material, the material may be the same as or different from the ceramic material of the insulation.

Suitable metal alloys include heat-resistant steels such as 1.25Cr-0.5Mo steel.

Where the ring baffle comprises, or is made from, a metal alloy, it may have a thickness in a range from about 0.25 cm to about 2 cm.

Suitable refractory ceramic materials for the ring baffle include carbides, nitrides and oxides of elements such as silicon, aluminium, magnesium, calcium, boron, chromium and zirconium. Particular examples include oxides of aluminium (alumina), silicon (silica), magnesium (magnesia) and calcium (lime).

Where the ring baffle comprises, or is made from, a ceramic material, it may have a thickness in a range from about 2.5 cm to about 10 cm.

The ring baffle may be cast with the second insulated end wall. In other embodiments, the ring baffle is made from bricks of refractory ceramic, e.g., alumina.

The ring baffle is typically the only baffle in the reactor. However, in some embodiments, the reactor further comprises at least one other baffle such as an annular plate baffle located on the insulated cylindrical side wall and extending, typically perpendicularly, from the side wall into the combustion chamber, typically up to (and usually no further than) the plurality of catalyst-containing tubes. Where present, the annular plate baffle is typically located at a point within a middle section of the cylindrical side wall, e.g., from about 30% to about 50% of the internal height of the combustion chamber as measured from the first end wall.

### Catalyst-Containing Tubes

In some embodiments, each catalyst-containing tube is formed from a single tube that is filled with catalyst. In these embodiments, the tubes extend through both the first and second insulated end walls of the reactor and feed gas is passed over the catalyst from an inlet at one end of each tube to form a product gas which leaves each tube via an outlet at the opposite end of the tube.

In other embodiments, each catalyst-containing tube comprises an inner tube located coaxially within an outer tube defining an annular space therebetween, the annular space being filled with the catalyst. In some of these embodiments, feed gas is passed over the catalyst in the annular space from an inlet at one end of each tube and the product gas then passes through the inner tube counter-currently to the flow of feed gas in the annular space, and leaves the tube via a product gas outlet at the same end of the tube as the feed gas inlet. However, in other embodiments, the feed gas flows in the opposite direction, i.e., through the inner tube first and then over the catalyst in the annular space between the inner and outer tubes.

The end of each tube opposite the end with the feed gas inlet/product gas outlet may not reach the opposite end wall. Thus, in these embodiments, there may be a gap between these ends of the catalyst-containing tubes and this end wall. However, in other embodiments, the ends of the tubes opposite the feed gas inlet/product gas outlet end may extend through the opposite end wall to enable improved access to the interior of the tubes.

The or each combustion gas outlet comprises a shroud extending from the second insulated end wall away from the combustion chamber defining an convection space around, or surrounding, a section of the catalyst-containing tube(s) outside of the combustion chamber. The combustion gas transfers heat to the tubes in the convection space to improve overall heat transfer. The section of the catalyst-containing tube(s) outside the combustion chamber is typically in a range from about 30% to about 50%, e.g., about 40%, of the length of the tube(s).

The catalyst in the tubes may be any catalyst suitable for endothermic reactions. Such reactions include steam reforming of hydrocarbon feedstock, e.g., methane, natural gas, liquefied petroleum gas (LPG) and naphtha, and cracking of ammonia.

In some preferred embodiments, the catalyst is an ammonia cracking catalyst such as a nickel-based catalyst, a ruthenium-based catalyst or an iron-based catalyst.

The term “nickel-based catalyst” refers to a catalyst containing nickel as the sole (or at least predominant) catalytically active metal, i.e., the metal responsible for catalyzing the cracking reaction. Nickel may be the only metal in the catalyst or alternatively one or more other metals may be present, e.g., in a material supporting the nickel such as a metal oxide like silica (SiO₂), alumina (Al₂O₃), zirconia (ZrO₂) or a mixed metal oxide support such as calcium aluminate or spinel (MgAl₂O₄) or perovskite (CaTiO₃) or a zeolite. The loading of the catalytically active metal(s) on the support may be from about 0.1 wt % to about 70 wt %. The terms “ruthenium-based catalyst” and “iron-based catalyst” are intended to be interpreted accordingly.

The skilled person is aware of many examples of suitable ammonia cracking catalysts including the catalysts disclosed in US2015/0217278A, Masel et al (Catalyst Letters, vol. 96, Nos 3-4, July 2004), Lamb et al (Int. J. Hydrogen Energy, 44 (2019) pp 3726-3736) and Boisen et al (J. Catalysis 230 (2005) pp 309-312).

In other preferred embodiments, the catalyst is a steam reforming catalyst such as a nickel-based catalyst, e.g., a nickel-alumina catalyst. The nickel-based catalyst may have an alkali metal promoter, e.g., potassium or magnesium. Steam reforming (or SMR) catalysts are well known in the art and any of the known catalysts may be used with the present invention. Examples of commercial reforming catalysts that are suitable for use with the present invention include the KATALCO™ series of catalysts (Johnson Matthey) and the ReforMax LDP series (Clariant).

### Method

The reactor is typically used to carry out an endothermic reaction. Thus, the invention provides in a second aspect a method comprising combusting a fuel with an oxidant gas in the burner(s) to heat the catalyst-containing tubes of the reactor according to the first aspect; and passing a feed gas through the catalyst-containing tubes to produce a product gas.

The feed gas may be hydrocarbon feedstock or ammonia.

Where the feed gas is ammonia, the catalyst is an ammonia cracking catalyst and the product gas is a cracked gas comprising hydrogen gas, nitrogen gas and residual ammonia gas.

In ammonia cracking reactions, the ammonia feed to the reactor typically comprises at least 98 mol. % ammonia, and is typically at a pressure in a range from about 5 bar to about 60 bar, and at a temperature in a range from about 400° C. to about 800° C. The flowrate of the ammonia feed is typically in a range from about 200 kilograms/hour (kg/h) to about 3500 kg/h.

The composition of the cracked gas will depend on the composition of the ammonia feed, together with the temperature and pressure of the cracking reaction which dictate the amount of ammonia slip. In this regard, the ammonia slip is typically in a range from about 0.1 mol. % to about 5 mol. %. The temperature of the cracked gas exiting the catalyst bed is typically in a range from about 500° C. to about 700° C. and the pressure of the cracked gas is typically in a range from about 30 bar to about 40 bar.

Where the feed gas is a hydrocarbon feedstock, the catalyst is a steam methane reforming catalyst and the product gas is syngas comprising hydrogen gas and carbon monoxide gas.

In steam reforming reactions, the hydrocarbon feedstock, mixed with the steam, is typically at a pressure in a range from about 8 bar to about 40 bar, and at a temperature in a range from about 400° C. to about 600° C. Steam would be present to give a ratio of steam to carbon atoms associated with hydrocarbons in a range from about 2:1 to about 6:1. The flow rate will depend on the identity of the hydrocarbon feedstock. Where the feedstock is natural gas, the flowrate is typically from about 70 kg/h to about 15,000 kg/h, e.g., from about 140 kg/h to about 1500 kg/h.

The composition of the product gas will depend on the composition of the hydrocarbon feedstock, together with the temperature and pressure of the steam reforming reaction which dictate the amount of residual reactants in the product gas. For steam methane reforming, the amount of methane slip is typically in a range from about 0.25 mol. % to about 5.0 mol. % on a dry basis. The temperature of the product gas exiting the catalyst bed is typically in a range from about 750° C. to about 950° C. and the pressure of the product gas is typically in a range from about 5 bar to about 40 bar.

The combustion process in the reactor may be at least partially fuelled internally using offgas generated during recovery of hydrogen from the product gas. The combustion process in the furnace is preferably internally fuelled, i.e., the fuel is either ammonia or an offgas generated during recovery of hydrogen from the cracked gas or a mixture of the two. That said, a trim fuel such as LPG, naphtha, ammonia, natural gas or methane, preferably derived from biogas or from methanation of renewable hydrogen, may be used to supplement the primary fuel.

When fed to the burner(s), the fuel is typically at a pressure in a range from about 1 bar to about 3 bar and the temperature is in a range from about −20° C. to about 250° C., e.g., from about 40° C. to about 250° C. for offgas generated during hydrogen recovery and from about −20° C. to about 250° C. or about −20° C. to about 40° C. for natural gas. The flow rate will depend on the identity or composition of the fuel used. Where the primary fuel is offgas generated during recovery of hydrogen from the product gas, the total flowrate may typically be in a range from about 30 kg/h to about 3600 kg/h. The flow of trim fuel is typically no more than about 150 kg/h, e.g., from about 10 kg/h to about 100 kg/h for natural gas.

The oxidant gas is typically air but may be an oxygen-enriched gas, e.g., oxygen-enriched air, or pure oxygen as appropriate.

In embodiments in which the oxidant gas is air, when fed to the burner(s), the air is typically at a pressure in a range from about 0.9 bar to about 1.2 bar, and at a temperature in a range from ambient (which may be as low as −20° C.) to about 250° C. and has a flowrate in a range from about 150 kg/h to about 5400 kg/h. The excess air will range from about 5% to about 80%.

The composition of the combustion (or flue) gas from an ammonia cracking application will depend on the identity of the fuel and the oxidant gas. However, where the fuel is offgas from a hydrogen recovery process on the product gas supplemented with natural gas, and the oxidant gas is air, the combustion gas typically comprises nitrogen (70-80%), argon (0.5-1.0%), oxygen (1-5%), carbon dioxide (1-5%), and water (10-20%). If hydrogen or ammonia or cracked gas is used as the trim fuel, there would be no carbon dioxide in the flue gas, other than that drawn in with the combustion air. The levels of oxygen and argon are determined by the level of excess air used in the combustion, as is the nitrogen although most of the nitrogen comes from the PSA offgas as that contains all of the nitrogen atoms that were in the feed ammonia. Excess air should be kept to a practical minimum to maximise the efficiency of the process. The practical minimum is determined by the level required for stable combustion.

In an SMR application, the flue gas would have the same components although in different proportions, viz. carbon dioxide (10-20%, e.g., 13.5%), oxygen (3-15%, e.g., 6.75%), 64.5% nitrogen (60-70%, e.g., 64.5%), water (10-20%, e.g., 15.3%), and argon (0.5-3.0%).

For either application, the pressure of the combustion gas is typically in a range from about 0.8 bar to about 1.1 bar and its temperature is typically in a range from about 400° C. to about 650° C.

The furnace duty of the reactor (based on LHV of the fuel) may be in a range from about 90 kiloWatts (KW) to about 4500 kW and the tube duty may be in a range from about 4 kW/tube to about 60 kW/tube.

The number of tubes in the reactor is typically in a range from 12 to 72 and the number of burners is typically one but more, e.g., up to three, could be used.

The combustion chamber typically has an internal height in a range from about 0.9 metres (m) to about 4 m and an internal diameter in a range from about 1 m to about 5 m.

In some embodiments, the ratio of the internal diameter to the internal height of the combustion chamber of the reactor is in a range from about 1.3:1 to about 1.5:1, the internal diameter of the ring baffle is in a range from about 65% to about 75% of internal diameter of the combustion chamber, and the height of the ring baffle is in a range from about 8% to about 25% of the internal height of the combustion chamber. Additionally, the reactor typically has a single non-premixed burner.

In some other embodiments where the reactor has a single non-premixed burner and the ratio of the internal diameter to the internal height of the combustion chamber of the reactor is in a range from about 1.3:1 to about 1.5:1, the internal diameter of the ring baffle is in a range from about 75% to about 85% of internal diameter of the combustion chamber, and the height of the ring baffle is in a range from about 15% to about 25% of the internal height of the combustion chamber.

Aspects of the invention include:

#1. A reactor comprising:
a. an insulated cylindrical side wall having a first end and a second end opposite the first end, said cylindrical side wall being closed at the first end with a first insulated end wall and at the second end with a second insulated end wall, the insulated cylindrical side wall and insulated end walls defining a combustion chamber having an internal diameter, an internal height and a longitudinal axis parallel to the cylindrical side wall;
b. at least one burner located centrally in the first insulated end wall;
c. a plurality of catalyst-containing tubes extending through one of the insulated end walls into the combustion chamber towards the opposite insulated end wall, said tubes being parallel to the insulated cylindrical side wall and arranged in a circular array that is coaxial with the longitudinal axis of the combustion chamber;
d. at least one outlet for combustion gas extending through the insulated end wall through which the plurality of catalyst-containing tubes extends, said at least one outlet being located adjacent said tubes; and
e. a ring baffle located on the second insulated end wall and extending from the second insulated end wall into the combustion chamber, said ring baffle being coaxial with the longitudinal axis of the combustion chamber,
wherein the circular array of the plurality of catalyst-containing tubes is located between the ring baffle and the insulated cylindrical side wall, and
wherein the ring baffle has an internal diameter in a range from about 55% to about 90% of the internal diameter of the combustion chamber, and a height that is from in a range about 5% to about 30% of the internal height of the combustion chamber.

#2. A reactor according to aspect #1, wherein the or, if there is more than one, each burner is a non-premixed burner.

#3. A reactor according to aspect #1 or aspect #2, wherein the internal diameter of the ring baffle is in a range from about 65% to about 85%, or from about 65% to about 75%, or from about 75% to about 85%, of the internal diameter of the combustion chamber.

#4. A reactor according to any of aspects #1 to #3, wherein the height of the ring baffle is in a range from about 8% to about 25%, e.g., from about 8% to about 12% or from about 18% to about 22%, of the internal height of the combustion chamber.

#5. A reactor according to any of aspects #1 to #4 provided that, where the internal diameter of the ring baffle is at least 75% of the internal diameter of the combustion chamber, the height is at least about 15% of the internal height of the combustion chamber.

#6. A reactor according to any of aspects #1 to #4, wherein the internal diameter of the ring baffle is from in a range about 68% to about 72%, e.g., about 70%, of the internal diameter of the combustion chamber and the height is in a range from about 18% to about 22%, e.g., about 20%, of the internal height of the combustion chamber.

#7. A reactor according to any of aspects #1 to #5, wherein the internal diameter of the ring baffle is in a range from about 75% to about 85% of the internal diameter of the combustion chamber and the height is in a range from about 15% to about 25% of the internal height of the combustion chamber.

#8. A reactor according to any of aspects #1 to #7, wherein the ring baffle is a circular band extending perpendicularly from the second insulated end wall.

#9. A reactor according to any of aspects #1 to #8, wherein the ring baffle has a thickness in a range from about 0.1 cm to about 15 cm.

#10. A reactor according to any of aspects #1 to #9, wherein the ring baffle has a thickness in a range from about 0.25 cm to about 10 cm.

#11. A reactor according to any of aspects #1 to #10, wherein the ring baffle comprises a metal alloy or a ceramic material.

#12. A reactor according to any of aspects #1 to #11, wherein the ring baffle is made from alumina refractory bricks.

#13. A reactor according to any of aspects #1 to #11, wherein the ring baffle comprises, or is made from, a metal alloy and has a thickness in a range from about 0.25 cm to about 2 cm.

#14. A reactor according to any of aspects #1 to #11, wherein the ring baffle comprises, or is made from, a ceramic material and has a thickness in a range from about 2.5 cm to about 10 cm.

#15. A reactor according to any of aspects #1 to #14, wherein the ring baffle is cast with the second insulated end wall.

#16. A reactor according to any of aspects #1 to #15, wherein the ratio of the internal diameter (D) to internal height (h) of the combustion chamber is in a range from about 1:1 to about 2:1.

#17. A reactor according to any of aspects #1 to #16, wherein the plurality of catalyst-containing reactor tubes extends through the second insulated end wall towards the first insulated end wall.

#18. A reactor according to any of aspects #1 to #17, wherein said plurality of catalyst-containing tubes extend through both the first and second insulated end walls.

#19. A reactor according to any of aspects #1 to #18, wherein each catalyst-containing tube comprises an inner tube located coaxially within an outer tube defining an annular space therebetween, said annular space being filled with the catalyst.

#20. A reactor according to aspect #19, wherein there is a gap between the ends of the catalyst-containing tubes and the opposite insulated end wall.

#21. A reactor according to any of aspects #1 to #20, wherein the circular array of the plurality of catalyst-containing tubes is located adjacent the insulated cylindrical side wall.

#22. A reactor according to any of aspects #1 to #21, wherein the or each outlet comprises a shroud extending from the second insulated end wall away from the combustion chamber defining an annular convection space around, or surrounding, a section of the catalyst-containing tube(s) outside of the combustion chamber.

#23. A reactor according to aspect #22, wherein the section of the catalyst-containing tube(s) outside of the combustion chamber is in a range from about 30% to about 50%, e.g., about 40%, of the length of the tube(s).

#24. A reactor according to any of aspects #1 to #23, wherein the catalyst is an ammonia cracking catalyst or a steam methane reforming catalyst.

#25. A method of carrying out an endothermic reaction, said method comprising:
a. combusting a fuel with an oxidant gas in the burner(s) to heat the catalyst-containing tubes of the reactor according to any of aspects #1 to #24; and
b. passing a feed gas through the catalyst-containing tubes to produce a product (or “synthesis”) gas.

#26. A method according to aspect #25, wherein the feed gas is ammonia, the catalyst is an ammonia cracking catalyst and the product gas is a cracked gas comprising hydrogen gas, nitrogen gas and residual ammonia gas.

#27. A method according to aspect #25, wherein the feed gas is a hydrocarbon feedstock selected from the group consisting of methane, natural gas, LPG and naphtha or mixtures thereof, the catalyst is a steam methane reforming catalyst and the product gas is syngas comprises hydrogen gas and carbon monoxide gas.

#28. Use of a reactor as defined in any of aspects #1 to 24 to carry out an endothermic reaction.

#29. Use according to aspect #28, wherein the endothermic reaction is cracking of ammonia or steam methane reforming of hydrocarbon feedstock.

The invention will now be described by way of example only with reference to the figures.

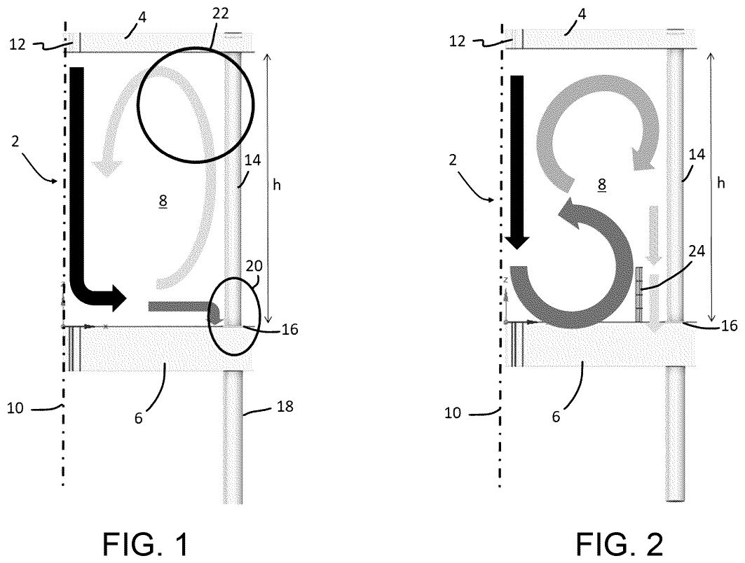

FIG. 1 depicts a 20° section of an annular reactor (2) according to the present invention. The section has two catalyst-containing tubes (although, as depicted, the second tube is largely hidden behind the first tube). It will be appreciated that the reactor (2) would actually have 18 such sections and hence 36 tubes in total.

According to FIG. 1, the reactor (2) has an insulated cylindrical side wall (not shown), an insulated first end wall (4) and an insulated second end wall (6) defining a combustion chamber (8). The combustion chamber (8) has an internal diameter (not shown), an internal height (h) and a longitudinal axis (10).

In this arrangement, the first end wall (4) forms the roof of the combustion chamber (8) and the second end wall (6) forms the floor of the combustion chamber (8). For convenience, the first and second end walls (4, 6) will be referred to going forward as the roof (4) and floor (6) respectively.

A non-premixed burner (12) is located centrally, i.e., coaxially with the longitudinal axis (10) of the combustion chamber (8), in the roof (4).

While only two tubes are shown, a plurality of catalyst-containing tubes (14) extends through the floor (6) into the combustion chamber (8) towards the roof (4) opposite. The tubes (14) are parallel to the cylindrical side wall (not shown) and arranged in a circular array that is coaxial with the longitudinal axis (10) of the combustion chamber (8). The catalyst may be an ammonia cracking catalyst such as a ruthenium-based catalyst or a nickel-based catalyst, or a steam reforming catalyst such as a nickel-based catalyst.

There is an annular outlet (16) for combustion gas extending through the floor (6) adjacent to and surrounding each tube (14). A tubular shroud (18) is located around a section of each tube (14) that extends away from the combustion chamber (8). The annular space (not shown) between the outside surface of the tube (14) and the inside surface of the shroud (18) forms a convection space (not shown) in which heat transfer from hot combustion gas to the tube (14) takes place.

As indicated by the arrows within the combustion chamber (8), hot combustion gas is generated by the burner (12) and flows generally downward from the roof (4) of the combustion chamber (8) to the floor (6). The gas is then deflected by the floor (6) and tends to move radially towards the cylindrical side wall (not shown). The Inventors have determined that a significant portion of the combustion gas then leaves the combustion chamber (8) directly through the combustion gas outlet (16) and only the remaining portion of the gas circulates around the chamber (8).

This flow pattern results in the generation of a “hot band” (indicated generally at 20) around the wall of each tube (14), near the outlet (16) which could be detrimental to the integrity of the tubes (14) at that point. A low temperature zone (22) is also created towards a section of the tubes (14) near the roof (4) of the combustion chamber (8). The uneven heat distribution adversely impacts the efficiency of the catalytic reaction within the tubes (14).

The section of the reactor (2) depicted in FIG. 2 is identical to the section of the reactor (2) depicted in FIG. 1 with the exception of a ring baffle (24) as described further below. The features that are common between FIGS. 1 & 2 have been given the same reference numerals. The following is a discussion of the distinguishing feature(s) only.

The ring baffle (24) is located on the floor (6) of the combustion chamber (8) and extends into the combustion chamber (8). The ring baffle (24) is located coaxially with the longitudinal axis (10) of the combustion chamber (8) and has an essentially rectangular cross section. The circular array of the plurality of catalyst-containing tubes (14) is located between the ring baffle (24) and the cylindrical side wall (not shown).

In this arrangement, the ring baffle (24) has an internal diameter of about 70% of the internal diameter of the combustion chamber (8), and a height that is about 20% of the internal height of the combustion chamber (8).

As indicated by the arrows in the combustion chamber (2), the ring baffle (24) has the effect of diverting and recirculating the combustion gas around the combustion chamber (8), thereby increasing the residence time of the combustion gas in the chamber (8) and providing a more even heat distribution to the tubes (14). The overall heat transfer is improved by up to about 10% and the tube wall temperature near the combustion gas outlet (16) is reduced by up to about 100° C., e.g., about 70° C.

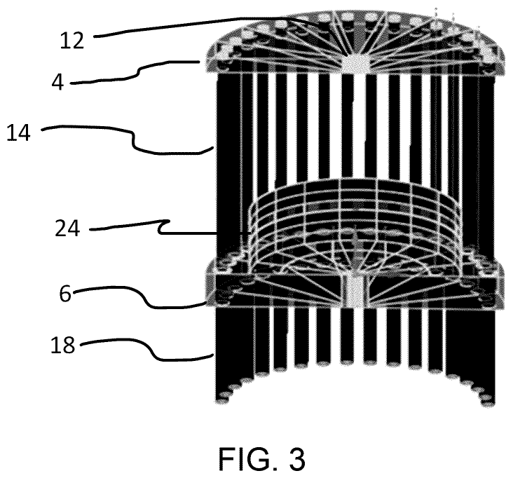

FIG. 3 is a cross-section of a reactor according to the present invention having thirty-six tubes, eighteen of which are depicted. The reactor has a first insulated end wall (4) —or roof—and a second insulated end wall (6) —or floor—opposite the first insulated end wall (4). A non-premixed burner (12) is located in the middle of the first insulated end wall (4) and the catalyst-containing tubes (14) extend through the second end wall (6) to the first end wall (4) in a circular arrangement. A shroud (18) surrounds the section of each tube (14) that extends beyond the second end wall away from the combustion chamber. A ring baffle (24) is positioned on the second end wall (6) and extends into the combustion chamber. The insulated cylindrical side wall is not shown in the figure.

It will be understood that, while the reactor in FIG. 3 is depicted as being constructed from a plurality of 20° sections having two tubes like the section depicted in FIG. 2, in reality the reactor would not be divided into sections in this way.

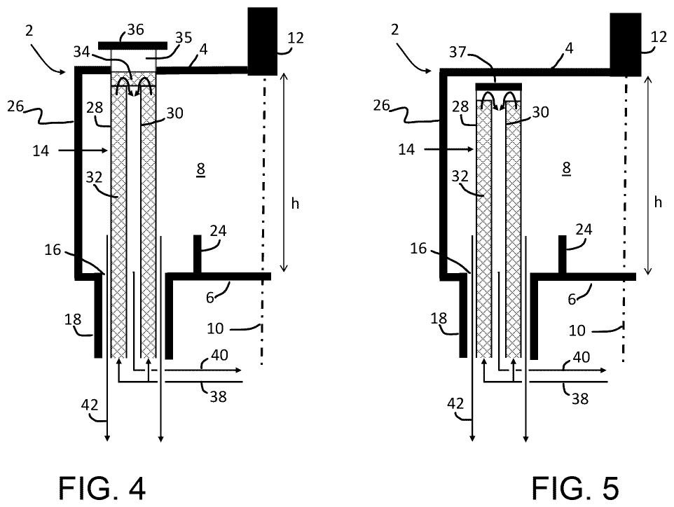

FIG. 4 is a partial cross section of another reactor (2) according to the present invention of the type depicted in FIGS. 2 & 3. The skilled person would appreciate that only the left-hand side is depicted but that the right-hand side is simply a mirror image of the left-hand side.

The features that are common between FIGS. 2 to 4 have been given the same reference numerals. The following is a discussion of the distinguishing feature(s) only.

The tube (14) is depicted in cross-section. Thus, the tube (14) can be seen to have an outer tube (28), together with an inner tube (30) located coaxially within the outer tube (28). A catalyst fills the annual space (32) defined by the outer and inner tubes (28, 30). In this embodiment, there is a plug (34) of catalyst located at the top end of the tube (14) covering the opening to the inner tube (30). The outer tube (28) extends through the roof (4) of the combustion chamber (8) and is closed first with an insulating plug (35) and then with a gasket (36) which provides access to the catalyst.

A stream (38) of feed gas, in this case ammonia, is passed through the catalyst in the annular space (32) where it is cracked to form a cracked gas comprising hydrogen gas, nitrogen gas and residual ammonia gas. The cracked gas passes through the inner tube (30), transferring heat via the wall of the inner tube to the gas being cracked over the catalyst in the annular space (32), before leaving the reactor (2) via an outlet (not shown) as stream (40).

Combustion gas exits the combustion chamber (8) via the outlet (16) and passes through the convection shroud (18) wherein the combustion gas transfers heat to the gas being cracked over the catalyst in the annular space (32) before leaving the reactor (2) as a stream (42) of flue gas.

FIG. 5 depicts alternative to the reactor (2) depicted in FIG. 4. The features that are common between FIGS. 4 & 5 have been given the same reference numerals. The following is a discussion of the distinguishing feature(s) only.

The reactor (2) of FIG. 5 is distinguished over the reactor (2) of FIG. 4 in that the tubes (14) do not extend all the way through the combustion chamber (8) and instead there is a gap between an end cap (37) and the roof (4) of the combustion chamber.

### EXAMPLES

CFD simulations were performed using the Ansys Fluent software (ver. 2023) to model the flow of combustion gas in a tube reactor comprising a single non-premixed burner and a combustion chamber having an aspect ratio (internal diameter to internal height) in the range from 1.3:1 to 1.5:1 used to crack ammonia using a nickel-based catalyst.

Identical simulations were performed for reactors without a ring baffle and for reactors with ring baffles having different heights and internal diameters as described below.

The model was made of multiple fluid (furnace and inside process tubes) and solid (tubes, shroud, and refractory walls) volumes. All volumes were solved at the same time and heat transfer across them was modeled using a conjugate heat transfer approach.

To reduce computational effort, most of the simulations were performed on a one eighteenth ( 1/18) section of a reactor having thirty-six tubes. The section therefore had two tubes. An eight-tube simulation was also performed to ensure the observed flow pattern was not induced by the reduced model. Multiple meshes were tested to ensure a mesh independent solution. For the two tubes model, the final mesh was made of approximately 5 million volumes.

For the furnace side, the following models were included:
turbulence modelling
turbulence combustion interaction
simplified combustion kinetics based on default Fluent models for H₂-rich flames
radiant heat transfer in participating media
gas emissivity as function of temperature and composition

Fluid model for the tube side included:
turbulence modelling
porous media definition based on catalyst data
custom enhanced heat transfer according to Nimvari 2003 model
ammonia cracking kinetics for a ruthenium-based catalyst were modelled using rate equation No. 9 based on Lamb et al (Int. J. Hydrogen Energy, 44 (2019) pp 3726-3736)

Tubes, shrouds, and refractory walls were modelled as a grey-bodies with emissivity and material properties provided by the manufacturers.

### Boundary Conditions:

the two surfaces parallel to the tubes that define the reduced volume were modelled as periodic boundaries
at the burner inlet, we specified air and fuel (hydrogen recovery offgas primary fuel with natural gas trim fuel) mass flows, compositions, pressure, and temperatures with the ranges described above
at the process tube inlet, we specified process gas mass flow, composition, pressure and temperature within the ranges described above
at both furnace and tube outlet, we specified pressure with the range described above.

For the external surfaces of the furnace, a “mixed” boundary condition was used to simulate the effect of natural convection and radiation in atmosphere.

The furnace duty and tube duty were within the ranges identified above.

The simulations were carried out in respect of:
a reactor without a ring baffle;
a reactor with a ring baffle having an internal diameter of 50% of the internal diameter of the combustion chamber and a height of 15% of the internal height of the combustion chamber; and
a reactor with a ring baffle having an internal diameter of 70% of the internal diameter of the combustion chamber and a height of 20% of the internal height of the combustion chamber.

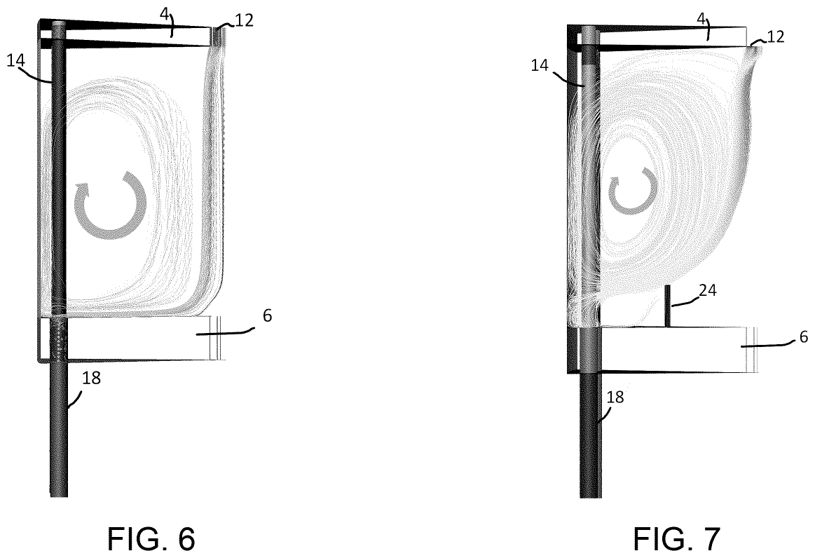

The problem being addressed was confirmed by simulation (a). In this regard, FIG. 6 clearly depicts a clockwise flow of combustion gas that impinges directly on the section of the tubes near the second insulated end wall (6), causing the formation of a hot zone on the tube walls at the furnace floor, before circulating back to the top of the reactor. A significant portion of the hot combustion gas also exits through the shroud (18) without recirculating. Such a flow pattern reduces heat transfer per tube and increases ammonia slip. The Inventors realized that this problem may be solved using a ring baffle.

However, the ring baffle (24) in simulation (b) did not solve the problem. In this regard, FIG. 7 shows the formation of a stagnant zone within the ring baffle (24) producing a clockwise top recirculation of combustion gas which again results in a higher tube wall temperature, lower heat flux and higher ammonia slip. The Inventors determined that the internal diameter of the ring baffle was too low.

The Inventors observed that the larger ring baffle (24) in simulation (c) redirects the flow of combustion gas to cause top recirculation in the anti-clockwise direction which reduces the temperature of the tube wall at the floor of the reactor and improves heat flux, thereby reducing ammonia slip.

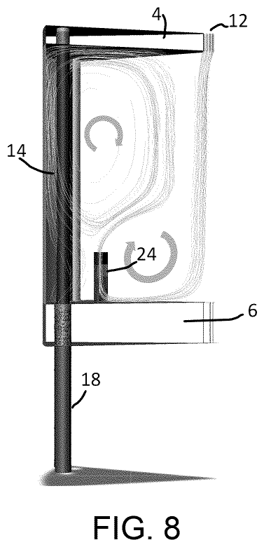

The skilled person would appreciate that the clockwise flow of combustion gas depicted in FIGS. 6 to 8 would actually be anti-clockwise on the opposite side of the combustion chamber. Similarly, the anti-clockwise flow depicted in FIG. 8 would actually be clockwise on the opposite side of the combustion chamber.

Results from simulations (a) and (c) are confirmed below in Table 1.

TABLE 1

| | | | Tube wall |
|---|---|---|---|
| | Heat transfer | | temperature at |
| Simulation | per tube | Ammonia slip | furnace floor |
| (a)-no ring baffle | 25 kW | 4% | 680° C. |
| (c)-ring baffle | 27 kW | 1.6% | 610° C. |

According to the data in the table, use of the ring baffle in simulation (c) improved heat transfer per tube by 8%, thereby reducing ammonia slip by about 60%. In addition, the tube wall temperature was reduced by 70° C.

While the invention has been described with reference to the preferred embodiments depicted in the figure, it will be appreciated that various modifications are possible within the spirit or scope of the invention as defined in the following claims.

In this specification, unless expressly otherwise indicated, the word “or” is used in the sense of an operator that returns a true value when either or both of the stated conditions are met, as opposed to the operator “exclusive or” which requires only that one of the conditions is met. The word “comprising” is used in the sense of “including” and incorporates “consisting of” rather than meaning “consisting of” exclusively.

All prior teachings above are hereby incorporated herein by reference. No acknowledgement of any prior published document herein should be taken to be an admission or representation that the teaching thereof was common general knowledge in Australia or elsewhere at the date thereof.

1. A reactor comprising:
an insulated cylindrical side wall having a first end and a second end opposite the first end, said cylindrical side wall being closed at the first end with a first insulated end wall and at the second end with a second insulated end wall, the cylindrical side wall and end walls defining a combustion chamber having an internal diameter, an internal height and a longitudinal axis parallel to the cylindrical side wall;
at least one burner located centrally in the first insulated end wall;
a plurality of catalyst-containing tubes extending through one of the insulated end walls into the combustion chamber towards the opposite insulated end wall, said tubes being parallel to the insulated cylindrical side wall and arranged in a circular array that is coaxial with the longitudinal axis of the combustion chamber;
at least one outlet for combustion gas extending through the insulated end wall through which the plurality of catalyst-containing tubes extends, said at least one outlet being located adjacent said tubes; and
a ring baffle located on the second insulated end wall and extending from the second insulated end wall into the combustion chamber, said ring baffle being coaxial with the longitudinal axis of the combustion chamber,
wherein the circular array of the plurality of catalyst-containing tubes is located between the ring baffle and the insulated cylindrical side wall, and
wherein the ring baffle has an internal diameter in a range from about 55% to about 90% of the internal diameter of the combustion chamber, and a height in a range from about 5% to about 30% of the internal height of the combustion chamber.

2. The reactor of claim 1, wherein the or, if more than one, each burner is a non-premixed burner.

3. The reactor of claim 1, wherein the internal diameter of the ring baffle is in a range from about 65% to about 85%, or from about 65% to about 75% or from about 75% to about 85%, of the internal diameter of the combustion chamber.

4. The reactor of claim 1, wherein the height of the ring baffle is in a range from about 8% to about 25% of the internal height of the combustion chamber.

5. The reactor of claim 1, wherein the ring baffle is a circular band extending perpendicularly from the second end wall.

6. The reactor of claim 1, wherein the ring baffle has a thickness in a range from about 0.1 cm to about 15 cm.

7. The reactor of claim 1, wherein the ring baffle is made from a metal alloy and has a thickness in a range from about 0.25 cm to about 2 cm.

8. The reactor of claim 1, wherein the ring baffle is made from a ceramic material and has a thickness in a range from about 2.5 cm to about 10 cm.

9. The reactor of claim 1, wherein the ring baffle is cast with the second insulated end wall.

10. The reactor of claim 1, wherein the ratio of the internal diameter (D) to internal height (h) of the combustion chamber is in a range from about 1:1 to about 2:1.

11. The reactor of claim 1, wherein the plurality of catalyst-containing reactor tubes extend through the second insulated end wall towards the first insulated end wall.

12. The reactor of claim 1, wherein said plurality of catalyst-containing tubes extend through both the first and second insulated end walls.

13. The reactor of claim 1, wherein each catalyst-containing tube comprises an inner tube located coaxially within an outer tube defining an annular space therebetween, said annular space being filled with the catalyst.

14. The reactor of claim 13, wherein there is a gap between the ends of the catalyst-containing tubes and the opposite insulated end wall.

15. The reactor of claim 1, wherein the circular array of the plurality of catalyst-containing tubes is located adjacent the insulated cylindrical side wall.

16. The reactor of claim 1, wherein the or each outlet comprises a shroud extending from the second insulated end wall away from the combustion chamber defining an annular convection space around a section of the catalyst-containing tube(s) outside the combustion chamber.

17. The reactor of claim 16, wherein the section of the catalyst-containing tube(s) outside the combustion chamber is in a range from about 30% to about 50% of the length of the tube(s).

18. A method of carrying out an endothermic reaction, said method comprising:
combusting a fuel with an oxidant gas in the burner(s) to heat the catalyst-containing tubes of the reactor of claim 1; and
passing a feed gas through the catalyst-containing tubes to produce a synthesis gas.

19. The method of claim 25, wherein the feed gas is ammonia, the catalyst is an ammonia cracking catalyst and the synthesis gas is a cracked gas comprising hydrogen gas, nitrogen gas and residual ammonia gas.

20. The method of claim 25, wherein the feed gas is selected from the group consisting of natural gas, LPG and naphtha, the catalyst is a steam reforming catalyst and the synthesis gas comprises hydrogen gas and carbon monoxide gas.
